(19) United States
(12) Patent Application Publication
(10) Pub. No.: US 2014/0007966 A1
(43) Pub. Date: Jan. 9, 2014

(54) PRELOADING GATE VALVE SYSTEM

(71) Applicant: James David McBride, Gladewater, TX (US)

(72) Inventor: James David McBride, Gladewater, TX (US)

(21) Appl. No.: 13/542,201

(22) Filed: Jul. 5, 2012

(51) Int. Cl. F16K 3/16; F16K 39/04; F16K 3/34

(52) U.S. Cl. 137/629; 251/327

(57) ABSTRACT

A preloading gate valve system is defined by preloading valve assembly integrated into a gate valve. The preloading gate valve system comprises: a gate valve; a gate; a preloading valve arrangement; and a means for control. The gate valve has an upstream cavity and a downstream cavity, and a gate disposed within the gate valve, wherein the gate is movable between open and closed position of the gate valve. The preloading valve arrangement defines an at least one preloading cavity and an at least one preloading valve. The at least one preloading cavity permits fluid to enter the gate valve through the at least one preloading cavity, through the at least one preloading valve, and into the gate valve. The means for control serves as a control interface allowing opening/closing of the gate.

### CROSS REFERENCE TO RELATED APPLICATIONS

This application contains subject matter related to subject matter contained in co-pending U.S. Ser. No. 13/440,120 (docket ECSDM1) filed on Apr. 5, 2012 and incorporated herein by reference.

### BACKGROUND

Gate valve component shearing and wear continues to be a problem. Fluid is often distributed to a gate valve under high pressure. This fluid pressure is often sealed off from the internal portions of the gate valve before opening/closing of the gate valve. During operation of the gate, such fluid enters the internal portions of the gate rapidly, and may cause damage and wear to gate valve components. Dirt, sand, and other sediment may flow into the gate valve, and cause further wear to gate valve components.

Conventional gate valve systems attempt to divert such high pressure fluid from the gate valve before gate operation. In such systems, a fluid pressure differential exists between upstream and downstream sides of the gate and the internal portions of the gate valve. As the gate opens/closes, fluid enters the gate valve and presses the gate against other internal components causing grinding and shearing. Rapid introduction of high pressure fluid pressure is exerted against gate valve surfaces in both opening and closing of the gate. Such rapid introduction of high fluid pressure can cause damage to gate valve components. Moreover, dirt, sand, and other sediment are still introduced to gate valve components. Therefore, a need exists for decreasing gate valve component shearing and wear during operation.

### SUMMARY

Embodiments of the invention are directed to decreasing gate valve component shearing and wear during operation. Embodiments of the invention permit fluid to be circulated into the gate valve prior to and during operation of the gate valve.

It is an objective of the invention to permit internal circulation of fluid during gate valve operation, thereby protecting gate valve surfaces from damage and wear. Such fluid circulation reduces the grinding of elements against the gate valve, reducing the risk of malfunction. Moreover, circulation of fluids during opening/closing reduces shearing forces on the gate and gate seal. Therefore, rapid shearing forces will be decreased to gate valve surfaces.

It is another objective of the invention to filter dirt, sand, and other sediment from high pressure fluid before entering the gate valve.

It is yet another objective of the invention to permit internal circulation of fluid during gate valve operation to prevent a sudden drop in pressure between gate valve surfaces during gate valve operation.

It is yet another objective of the invention to permit internal circulation of fluid during gate valve operation to allow such fluid pressure to open/close gate valve pressure equalization systems.

Embodiments of the invention implement a preloading gate valve system. The preloading gate valve system is defined by preloading valve assembly integrated into a gate valve. The preloading gate valve system comprises: a gate valve; a gate; a preloading valve arrangement; and a means for control. The gate valve has an upstream cavity and a downstream cavity, and a gate disposed within the gate valve, wherein the gate is movable between open and closed position of the gate valve. The preloading valve arrangement defines an at least one preloading relief port and an at least one preloading valve. The at least one preloading relief port permits fluid to enter the gate valve through the at least one preloading cavity, through the at least one preloading valve, and into the gate valve, and restricts the flow of dirt, sand, and sediment into the gate valve. The means for control serves as a control interface allowing opening/closing of the gate.

In a preferred embodiment, a gate valve has a gate centrally disposed within a valve body chamber. The gate valve has an upstream and downstream cavity and is sealed by a bonnet. A preloading valve arrangement comprises a preloading relief port depending through the valve body chamber to the upstream cavity, and a preloading valve seated into the valve body chamber at the preloading preloading relief port. A means for control is a handwheel attached to a non-rising stem capable of axial rotation, depending through the gate valve, and affixed to the gate. Fluid pressure is permitted to enter the valve body chamber located between the upstream cavity and downstream cavity, through the preloading valve.

### BRIEF DESCRIPTION OF THE DRAWINGS

These and other features, aspects and advantages of embodiments of the invention will become better understood with regard to the following description, appended claims, and accompanying drawings where:

FIG. 1 is a partial sectional perspective view of a preloading gate valve system according to an embodiment of the invention;

FIG. 2 is a cross-sectional side view of a preloading gate valve system in a closed position, according to the embodiment of FIG. 1;

FIG. 3 is a front view of a preloading gate valve system in an open position, according to the embodiment of FIG. 1;

FIG. 4 is a back view of a preloading gate valve system in an open position, according to the embodiment of FIG. 1;

FIG. 5 is a front exploded view of a handwheel, stem, and gate according to the embodiment of FIG. 1;

FIG. 6 is a perspective view of a gate, according to the embodiment of FIG. 1;

FIG. 7 is a cross-sectional front view of a gate, according to the embodiment of FIG. 1;

FIG. 8 is a cross-sectional side view of a gate, according to the embodiment of FIG. 1;

FIG. 9 is a bottom view of a bonnet, according to the embodiment of FIG. 1;

FIG. 10 is a perspective view of an upstream ring member, according to the embodiment of FIG. 1;

FIG. 11 is a perspective view of a downstream ring member, according to the embodiment of FIG. 1;

FIG. 12 is an exploded perspective view of a check valve, according to the embodiment of FIG. 1;

FIG. 13 is a partial cross-sectional top view of a gate valve without a bonnet, according to the embodiment of FIG. 1;

FIG. 14 is a cross-sectional side view of a gate valve body and preloading valve arrangement according to the embodiment of FIG. 1;

FIG. 15 is a cross-sectional side view of a gate valve body and preloading valve arrangement of an alternative embodiment of the invention;

FIG. 16 is a cross-sectional side view of a preloading gate valve system in a closed position, according to the embodiment of FIG. 15; and

FIG. 17 is an exploded perspective view of a plurality of check valves, according to the embodiment of FIG. 15.

### DESCRIPTION

Overview

The following detailed description illustrates the preferred embodiment of the invention. This description will clearly enable one skilled in the art to make and use the invention, and will set forth the best mode of doing so. The embodiments listed herein are not intended to limit the scope of the invention. Several alternative embodiments are set forth, and it is contemplated that the invention may include other permutations, arrangements, adaptations, uses, and variations of the inventive concept set forth herein.

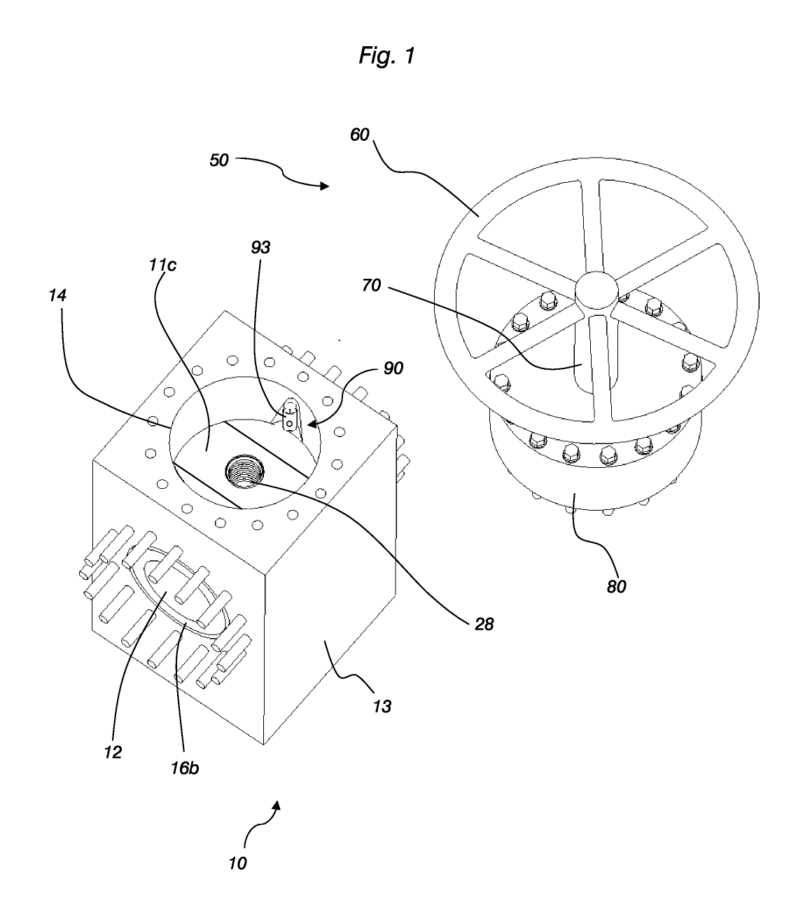

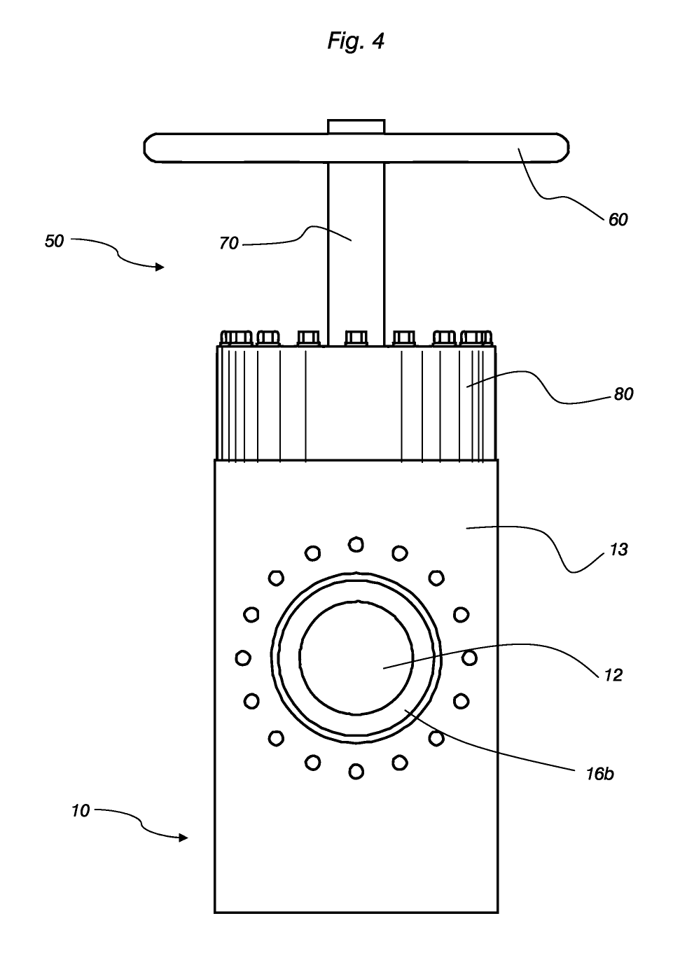

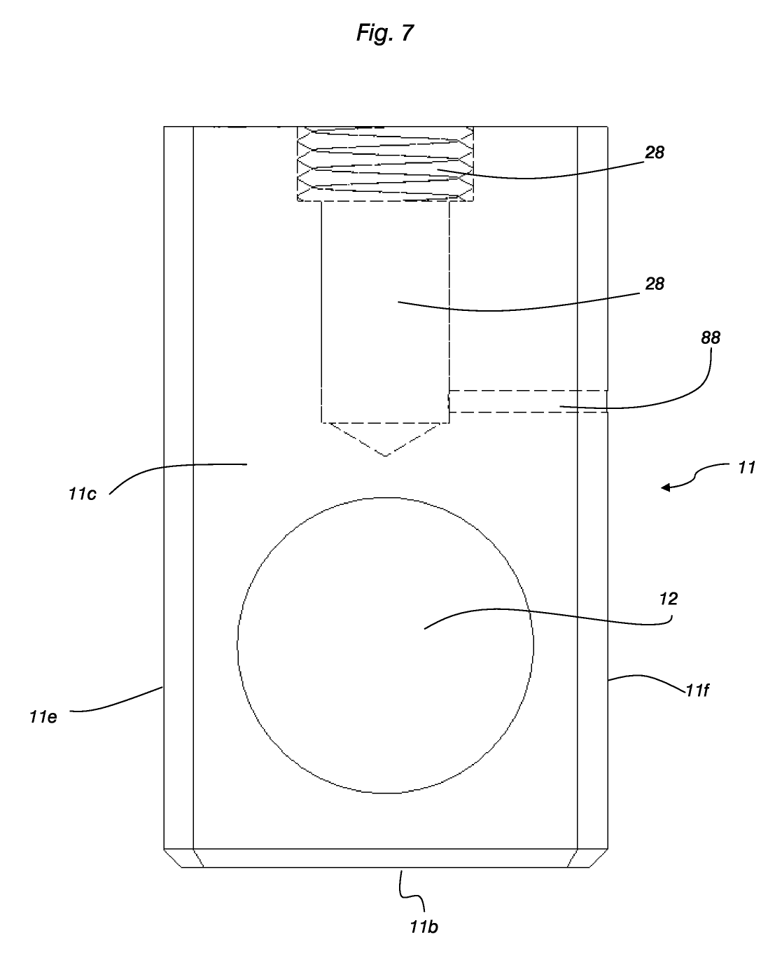

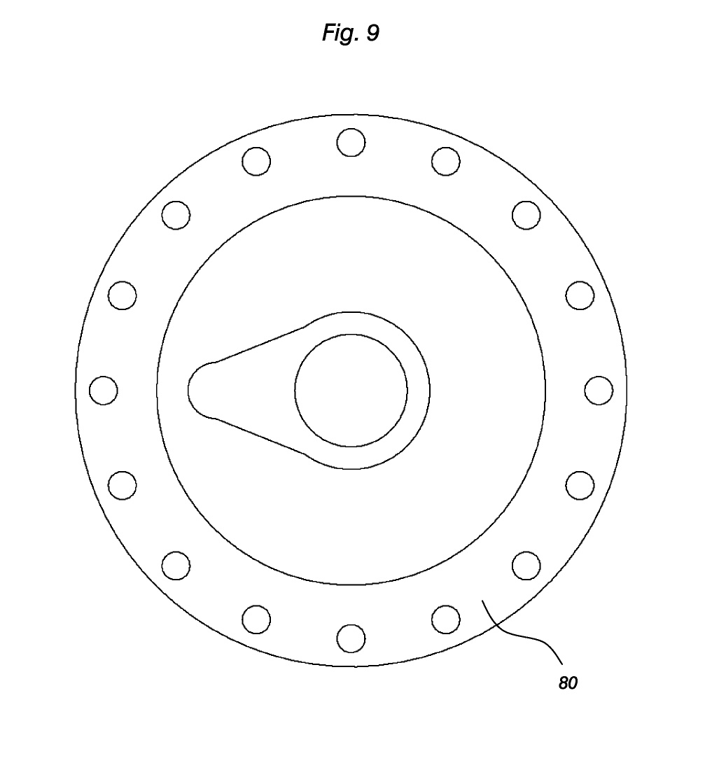

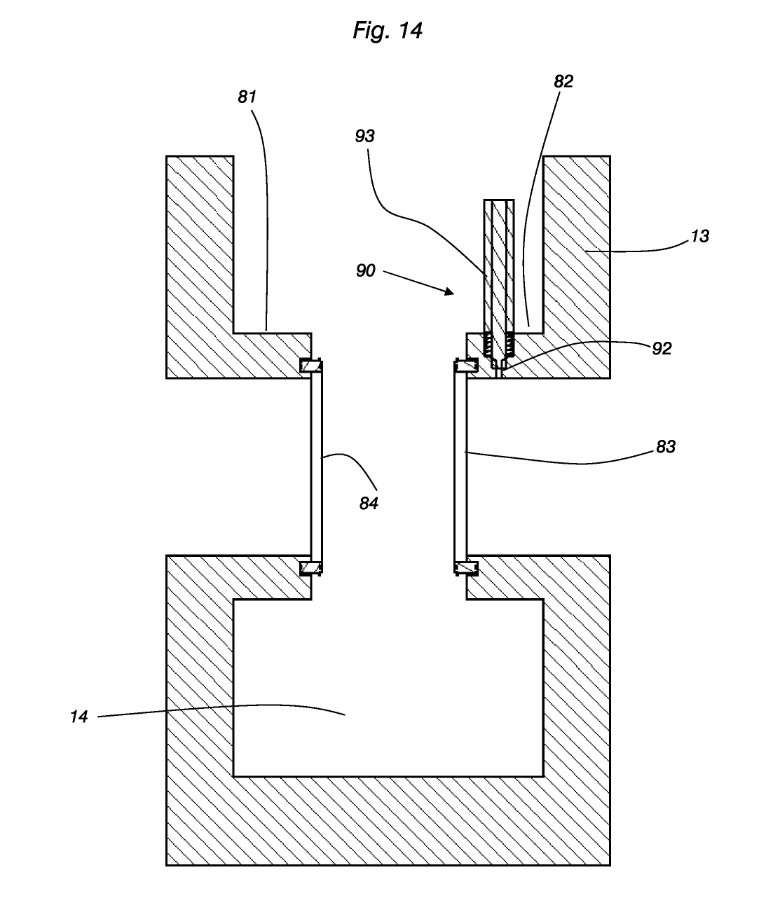

Referring to FIGS. 1-14, a preferred embodiment of a preloading gate valve system comprises: a gate valve 10; a gate 11 disposed within said gate valve 10, wherein said gate 11 is movable between open and closed position of said gate valve 10; a preloading valve arrangement 90 comprising a preloading relief port 92 and a check valve 93, wherein said check valve 93 permits fluid transfer from an upstream cavity 16a to a gate body chamber 14; and a means for control 50, wherein said means for control 50 permits opening and closing of said gate valve 10.

Detailed Description of a Preferred Embodiment

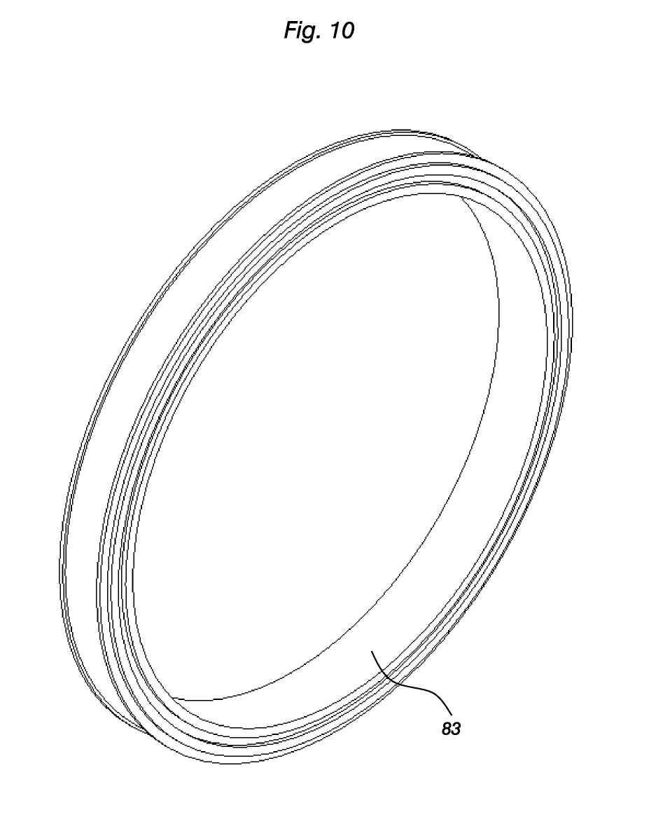

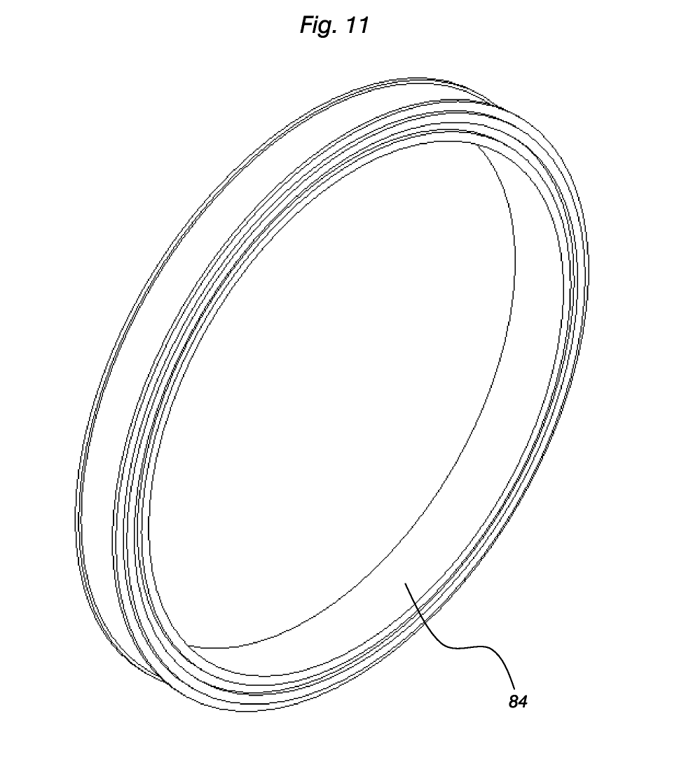

In reference to FIGS. 1-4, a gate valve 10 has a valve body 13, a valve body chamber 14, an upstream cavity 16a, and a downstream cavity 16b. A valve body 13 is a hollow resilient enclosure, permitting fluid transfer. A valve body chamber 14 is a cavity, depending through the central portion of the valve body 13. An upstream cavity 16a and downstream cavity 16b are elongate longitudinal apertures extending through opposing sides of the valve body 13. An upstream valve cavity housing 81 and downstream valve cavity housing 82 extend into the valve body chamber 14. The upstream valve cavity housing 81 and downstream valve cavity housing 82 extend around the upstream cavity 16a and downstream cavity 16b. An upstream ring member 81 and downstream ring member 82 are placed on the interior surface of the valve body 13, adjacent to the upstream cavity 16a and downstream cavity 16b. The upstream ring member 81 and downstream ring member 82 are resilient circular rings, as shown in FIGS. 10, 11. The gate valve 10 is sealed by a bonnet 80. The bonnet 80 is a resilient pressure sealed enclosure, fixedly attached to the valve body 13, as shown in FIGS. 1-4, 9.

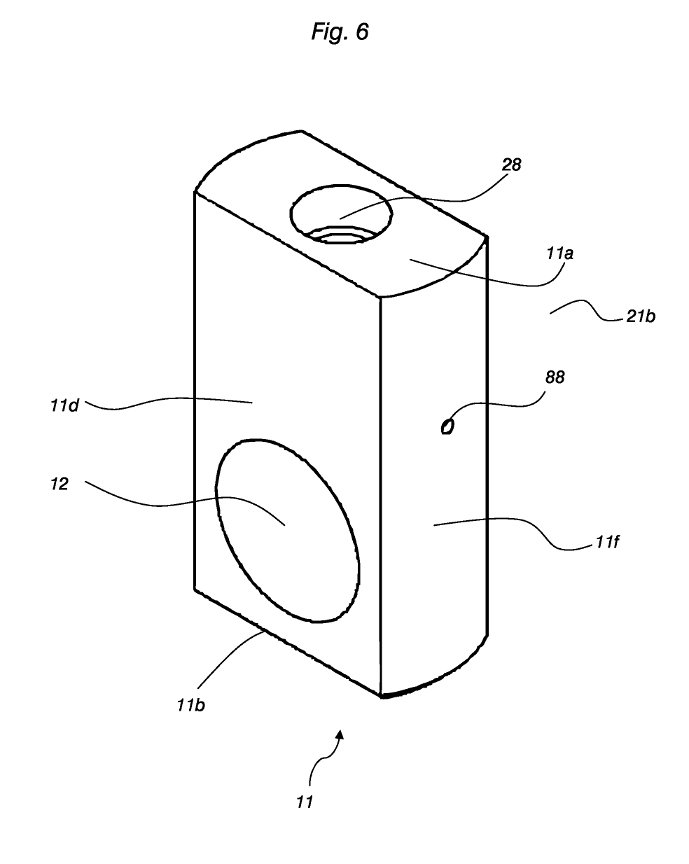

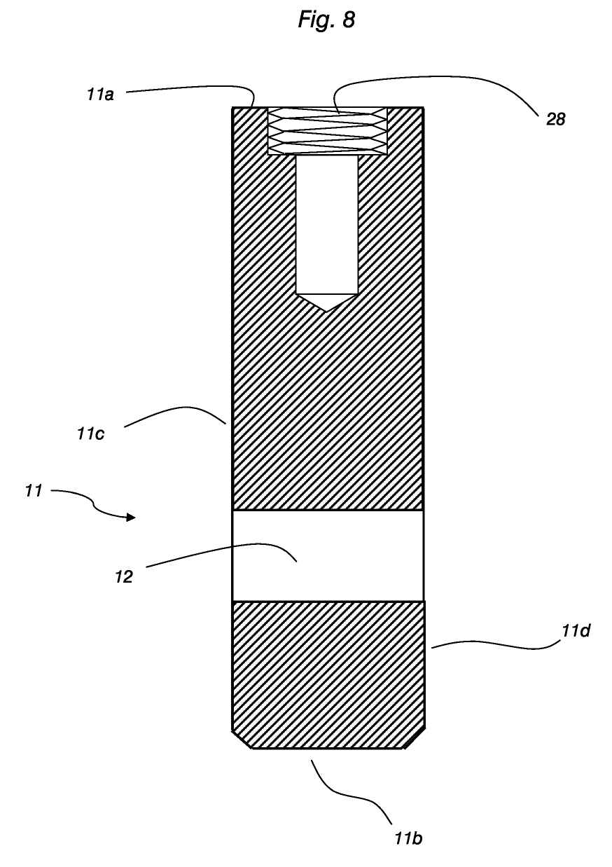

Referring to FIGS. 1-4, a gate 11 is movable between open and closed positions, and positioned within the valve body chamber 14. The gate 11 is a substantially planar resilient member, adapted to form a pressure fluid seal between the upstream cavity 16a and the downstream cavity 16b during operation. The gate 11 has six sides: an upper gate surface 11a; a lower gate surface 11b; an upstream gate surface 11c; a downstream gate surface 11d; and two gate side surfaces 11e, 11f, as shown in FIGS. 6, 8. The gate 11 has a gate cavity 12 and a stem cavity 28. A gate cavity 12 is an aperture extending longitudinally through the gate 11, from the upstream gate surface 11e to the downstream gate surface 11d. The nominal dimensions of the gate cavity 12 are approximately the same as the upstream cavity 16a and downstream cavity 16b. A stem cavity 28 is an aperture, centrally disposed on the upper gate surface 11a. The gate 11 may have a grease port 88 for the passage of lubrication fluids. During operation, the upstream gate surface 11e makes direct contact with the upstream ring member 81, forming a pressure seal. Conversely, the downstream gate surface 11d, makes direct contact with the downstream ring member 82, forming a pressure seal.

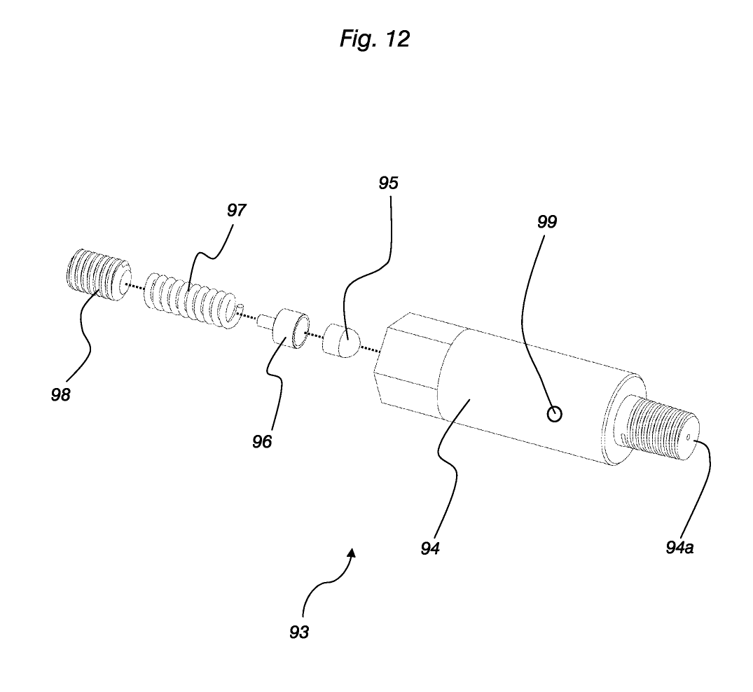

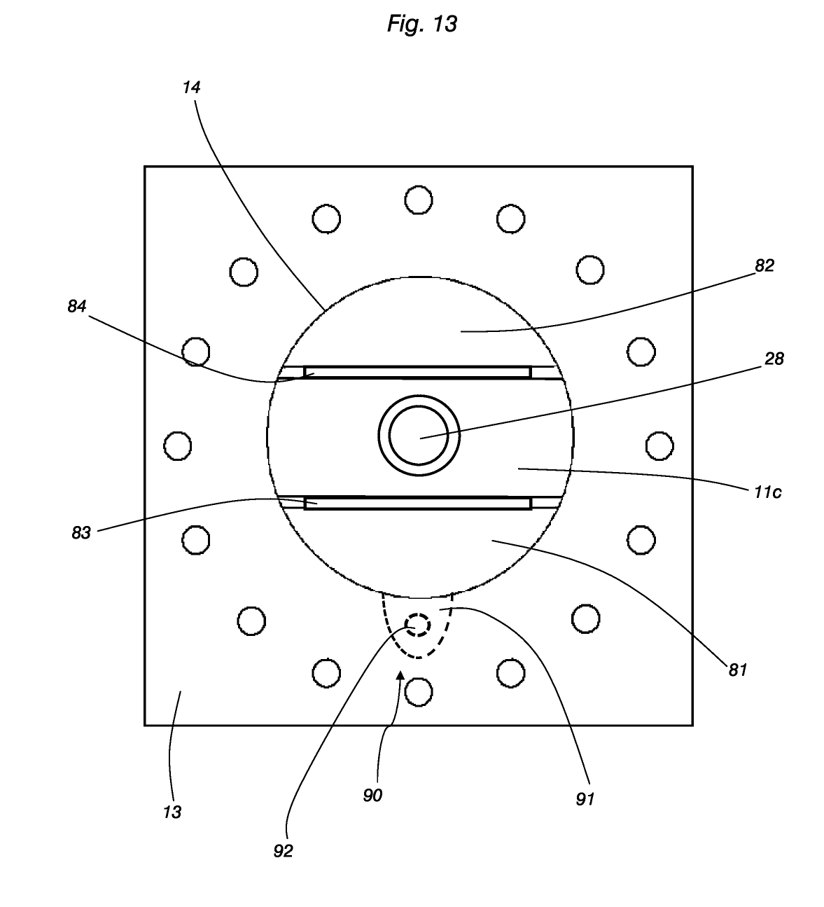

In reference to FIGS. 1, 2, 12-13, a preloading valve arrangement 90 is a fluid release valve system allowing fluid to enter the valve body chamber 14 from the upstream cavity 16a. The valve body relief arrangement 90 comprises a preloading relief port 92 and a check valve 93. A preloading relief port 92 is a downwardly depending aperture, extending from the upstream valve cavity housing 81 to the upstream cavity 16a, as shown in FIGS. 12-13. A check valve 93 is a fluid exchange valve, permitting fluid transfer. The check valve 93 of the exemplary embodiment comprises: a check valve body 94; a check valve seal tip 95; a check valve retainer 96; a check valve spring 97; a check valve nut 98; and a check valve escape port 99, as shown in FIG. 12. A check valve body 94 is a resilient elongate longitudinally extending hollow cylinder, with a threaded tip. An entrance port 94a is an aperture located on the tip of the check valve body 94a. A check valve seal tip 95 is a resilient elongate dome, forming a sealing surface. A check valve retainer 96 is a cylindrical housing member, adapted for placement of the check valve seal tip 95. A check valve spring 97 is an elongate spring, inserted into the interior of the check valve body 94. A check valve nut 98 is a threaded cylindrical nut, secured into the exterior of the check valve body 94. A check valve escape port 99 is an aperture extending from the exterior surface of the check valve body 94, to the interior surface of the check valve body 94. The body relief arrangement 90 has a valve relief recess 91 proximate to the upstream valve cavity housing 81, such that the entrance port 94a is aligned with the preloading relief port 92, as illustrated in FIG. 13.

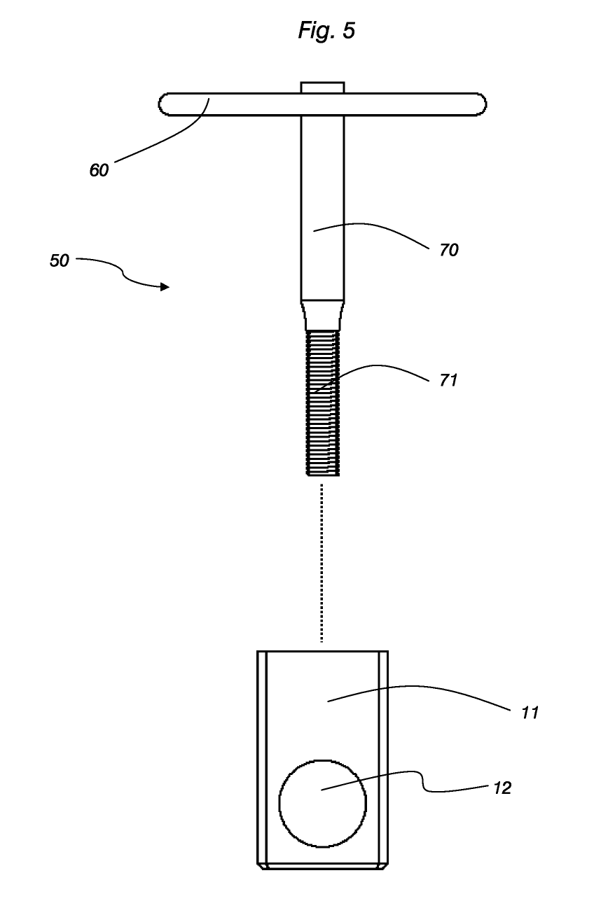

A means for control 50 is a control interface, allowing opening/closing of the gate valve 10. In the exemplary embodiment, a means for effectuating movement 50 comprises a stem 70 attached to a handwheel 60 as shown in FIG. 5. A stem 70 is a threaded member, centrally disposed through the slide nut 21 via a stem thread 71. The stem depends downwardly into the stem cavity 28. The stem 70 of the exemplary embodiment is a nonrising stem (although other types of stems are contemplated by embodiments of the invention), capable of axial rotation. Axial rotation of the stem 70 causes the gate 11 to rise/fall within the valve body chamber 14.

How the Invention is Used

Embodiments of the invention may be used in hydraulic fracturing in oil and gas operations. In the example of implementation of the preferred embodiment in such fracturing activities, hydraulic fluid is first delivered downstream through the gate valve 10 and into the wellbore under a pressure sufficient to the fracture gradient of the formation. Such hydraulic fluid is often comprised of water and other proprietary additives such as etching acidic compounds, causing fractures within the formation. Next, a proppant is injected downstream through the gate valve 10 and into the wellbore to prevent the fractures from closing during decreased pressure. In typical operations, the fluid pressure of the injected proppant is less than that of the fluid pressure of the injected hydraulic fluid.

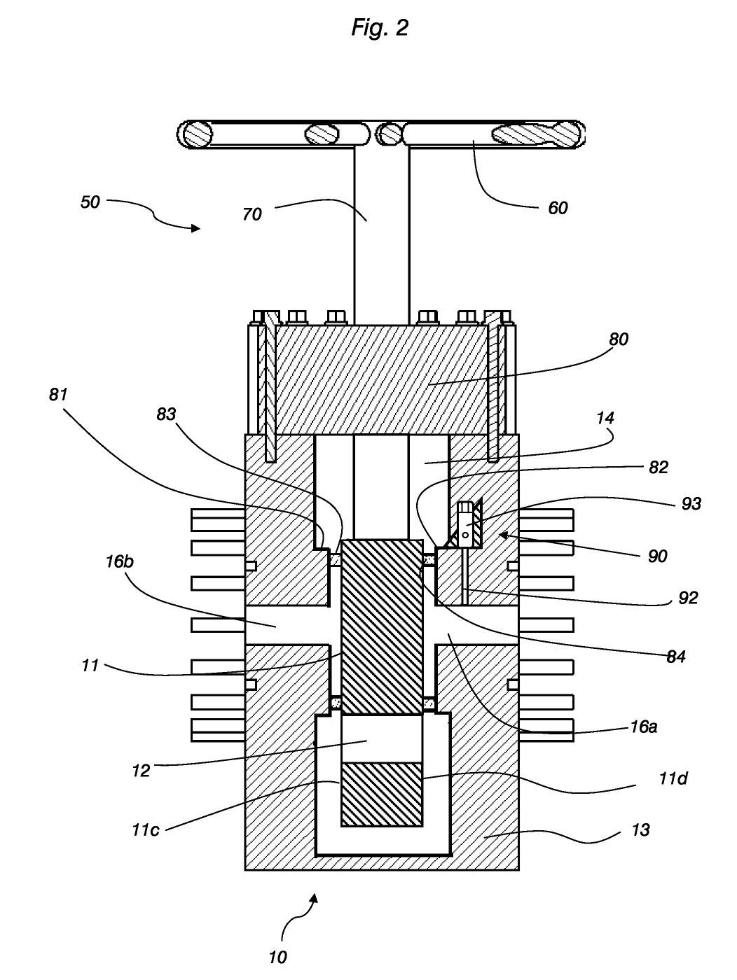

During operation of the gate valve 10 in hydraulic fracturing operations, the gate 11, operates between open and closed positions, within the gate valve 10. Prior to introduction of hydraulic fluids, the gate 11 is in a closed position, at a lowered position within the valve body chamber 14, as shown in FIGS. 1-2. Hydraulic fluid then enters the upstream cavity 16a under pressure. Hydraulic fluid then enters the preloading relief port 92 and compresses the check valve spring 97. Hydraulic fluid then circulates into the check valve body 94 through the entrance port 94a, through the escape port 99, and into the valve body chamber 14. Hydraulic fluid flows into the valve body chamber 14 and lubricates the gate valve 10 surfaces within the valve body chamber 14. The hydraulic fluid also increases the pressure inside the valve body chamber 14 prior to opening/closing.

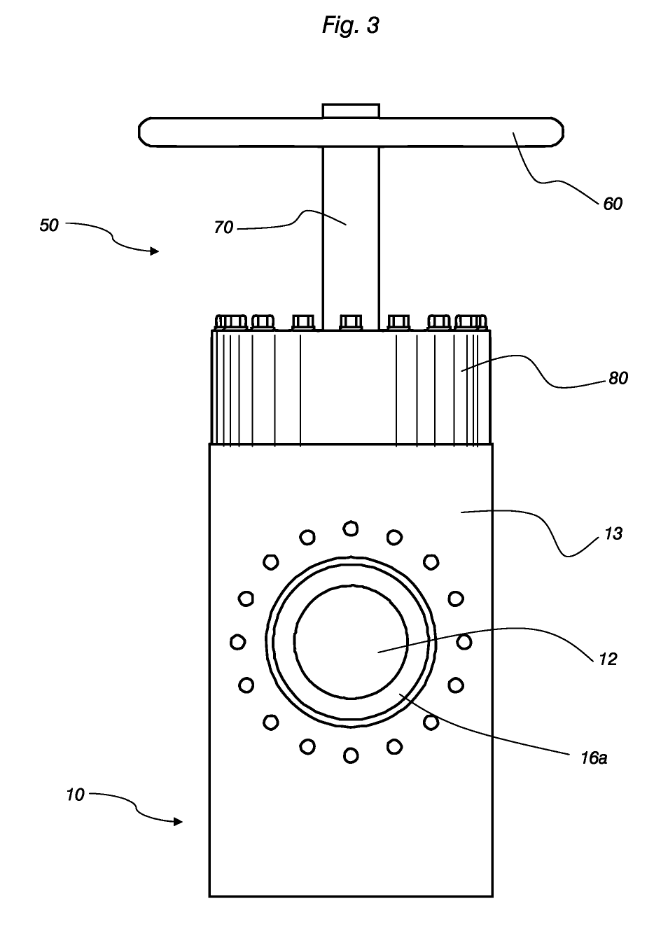

To open the gate 11, an operator begins to turn the handwheel 60 counter-clockwise. Turning of the handwheel 60 causes the stem 70 to axially rotate. Axial rotation of the stem 70 causes the gate 11 to rise within the valve body chamber 14 to an open position, wherein the gate cavity 12 is aligned between the upstream cavity 16a and downstream cavity 16b, as shown in FIGS. 2-3. Hydraulic fluid already present in the valve body reduces the shearing forces during the opening/closing motion of the gate 11. Fluid then flows from the upstream cavity 16a to the downstream cavity 16b, by passing through the gate cavity 12.

Hydraulic fluid introduction into the gate valve 10 causes a high fluid pressure level to exist within the gate valve body prior to opening/closing of the gate 11 and proppant injection. This high fluid pressure level acts downward on the check valve spring 97, compressing the check valve seal tip 95 against the entrance point 94a during proppant injection. As the fluid pressure level already present within the valve body is greater than the injected proppant, thereby restricting dirt, sand, and other sediment from entering the valve body. The result of such operation is to create a filter to permit undesirable sediment from entering the valve body.

To close the gate 11, the operator begins to turn the handwheel 60 clockwise. Turning the handwheel 60 clockwise lowers the gate 11 within the valve body chamber 14, until the flow of fluid is restricted by the presence of the gate 11 between the upstream cavity 16a and the downstream cavity 16b.

Embodiments of the invention decrease gate valve component shearing and wear during operation. The preloading gate valve system of embodiments of the invention allow fluid pressure to be circulated into the gate valve prior to and during operation of the gate valve. The preloading valve system and gate valve may be connected to a plurality of pipes or other couplers, in connection with fluid transfer. Embodiments of the invention may be used in conjunction with other gate valves, used individually, or used in series.

Advantages of the Invention

Embodiments of invention implement a preloading valve arrangement. As opposed to redirecting fluid from the interior of the gate valve, fluid is introduced within the gate valve through a preloading gate valve system prior to opening/closing. The introduced high pressure fluid causes the parts within the gate valve to immersed in fluid, thereby reducing shearing forces. Rapid introduction of fluid into the gate valve exerts less force against gate valve surfaces during opening/closing, due to a lessened pressure differential within the gate valve.

The preloading valve arrangement acts as a filter, and may trap dirt, sand, and other sediment before entering the gate valve and prevents erosion of metal material. The preloading valve arrangement also permits internal valve pressure to activate the pressure equalization systems (as opposed to using external fluid pressure). Moreover, the preloading valve arrangement prevents a sudden drop of pressure between the valve body chamber and valve body, and between the valve body chamber and gate.

The preloading valve arrangement may comprise a check valve (however alternative embodiments contemplate using a plurality of check valves or other valve types). A check valve (or plurality of check valves) may used to permit upstream fluid to enter the gate valve. Differing check valve springs may be used to regulate operation. For example, a check valve spring with greater spring tension may used where it is desirable for a certain given fluid pressure level.

Alternatives

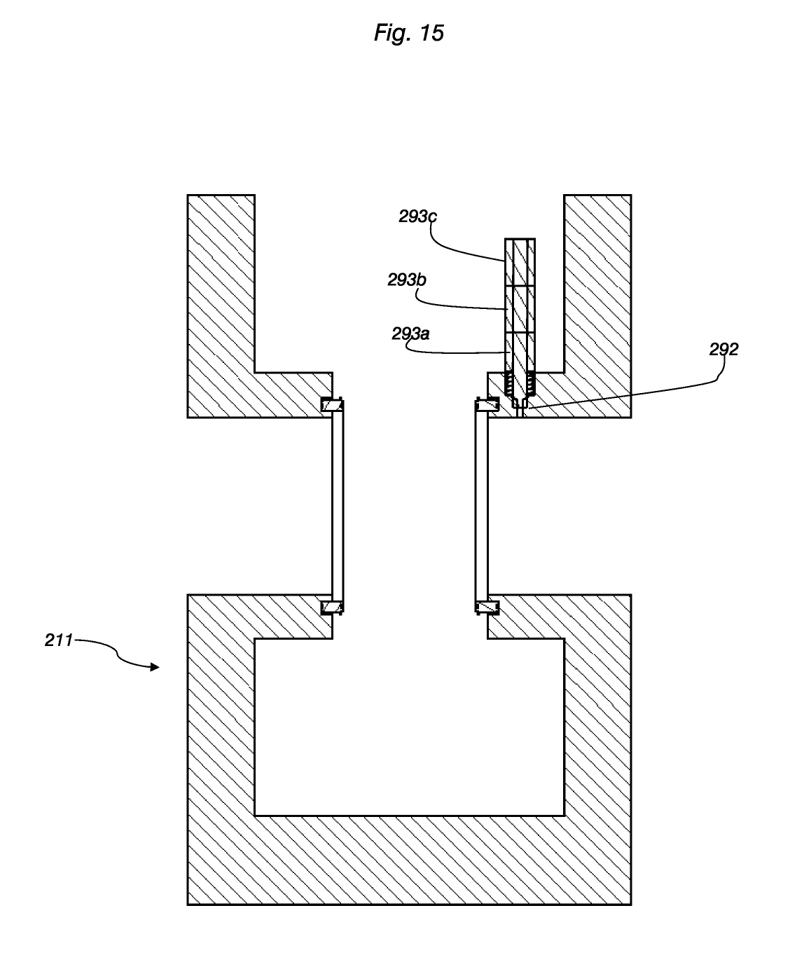

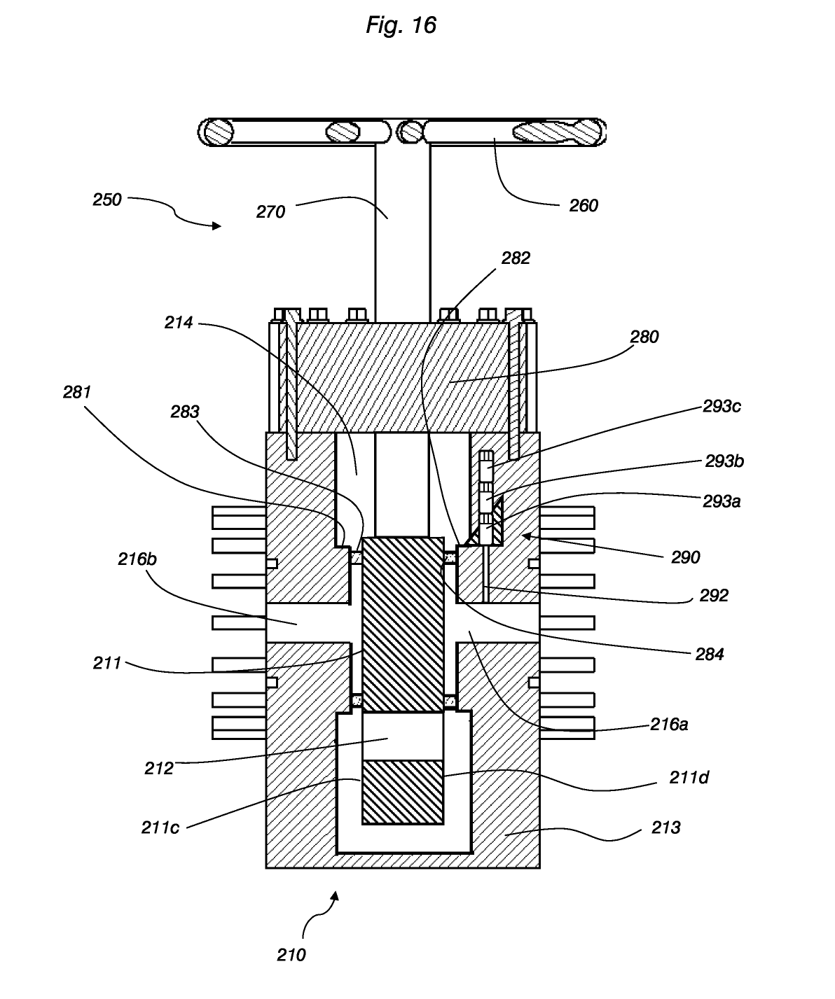

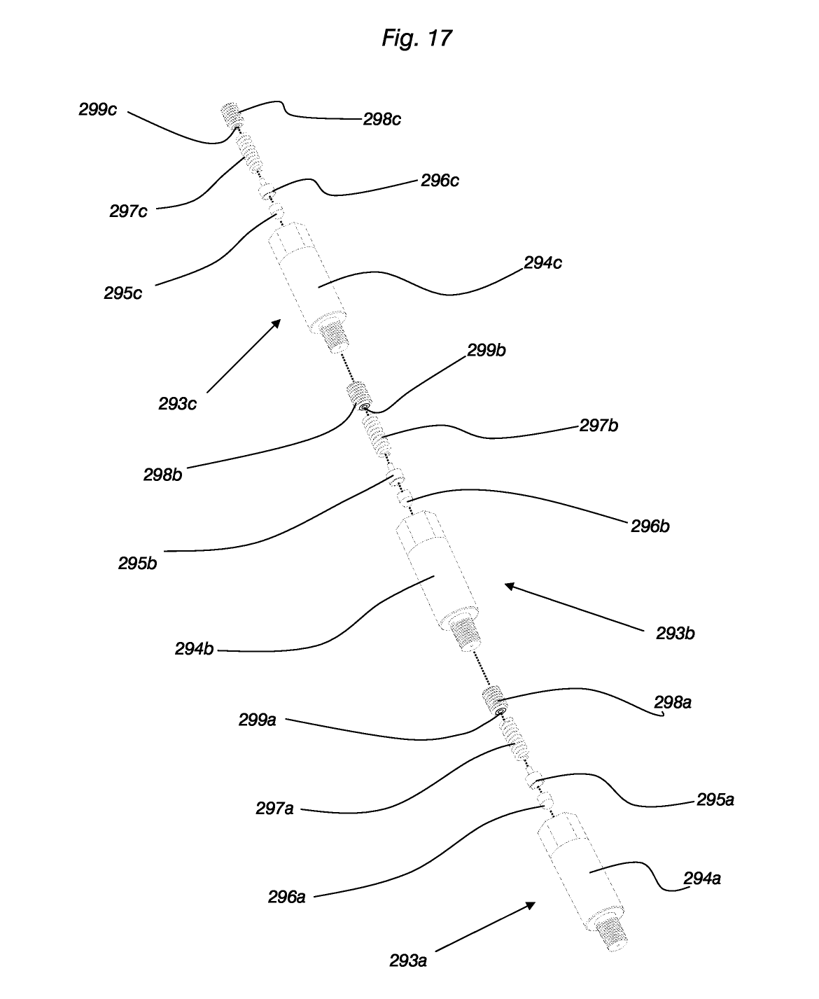

Referring to FIGS. 15-17, a first alternate embodiment of a gate valve pressure equalization system has a gate valve 210, a gate 211, a preloading valve arrangement 290, and a means for control 250. The preloading valve arrangement 290 comprises a preloading relief port 292 and three check valves 293a, 293b, 293c. A preloading relief port 292 is a downwardly depending aperture, extending from an upstream valve cavity housing 281 to an upstream cavity 216a. The check valves 293a, 293b, 293c are fluid exchange valves, permitting fluid transfer. The check valves 293a, 293b, 293c are stacked end-to-end, as shown in FIGS. 15-17. Each check valve 293a, 293b, 293c comprises: a check valve body 294a, 294b, 294c; a check valve seal tip 295a, 295b, 295c; a check valve retainer 296a, 296b, 296c; a check valve spring 297a, 297b, 297c; a check valve nut 298a, 298b, 298c; and a check valve escape port 299a, 299b, 299c, as shown in FIG. 17. A check valve escape port 299a, 299b, 299c is an aperture extending through the check valve nut 298a, 298b, 298c, as shown in FIG. 17. The check valves 293a, 293b, 293c are located proximate to the upstream valve cavity housing 281, aligned such that fluid may flow from the preloading relief port 292 into each check valve body 294a, 294b, 294c.

The physical arrangement and components described in the embodiments herein may include substitutions and equivalent structures. The scope of the invention herein includes such equivalencies. For example, the preloading valve arrangement may implement one or a plurality of valves. Such valves may be of differing types and permutations thereof, permitting an influx of fluid pressure prior to and during operation of the gate valve. The check valve may implement springs with varying tensions, or differing sized apertures. The placement and number of check valves in relation to the gate valve body may vary.

The gate may also be lowered into an open position and raised to closed position.

The exemplary embodiment describes a non-rising stem, however, the stem may also be rising stem.

Implementation of the inventive concept herein applies to gate valves. The term gate valve as it is used herein, may include differing types of gate valves including: a sluice valve; a knife gate; a slide gate; a parallel gate valve; a flexible wedge gate valve; a solid wedge gate valve; a split wedge gate valve; globe valve; or a parallel slide gate.

Differing types of check valves may be used, including: a spring-loaded pressure release valve; a ruptured disc and pin valve; or a balanced bellows valve.

The bonnet may also be: a screw-in bonnet; a union bonnet; or a pressure-sealed bonnet.

Differing combinations and permutations of the embodiments set forth are contemplated by the current invention. Additionally, all functional equivalents of materials used and means of attachment of elements are contemplated by the current invention. Therefore, the spirit and scope of the appended claims should not be limited to the descriptions of the preferred versions and alternate embodiments set forth herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of in the claims herein is not intended to invoke the provisions of 35 U.S.C. §112, ¶6.

What is claimed is:

1. A preloading gate valve system comprising:
a gate valve defining a valve body and valve body chamber;
a flow passage extending transversely through said valve body chamber between an upstream cavity and a downstream cavity;
a gate disposed within said gate valve body chamber, said gate movable between open and closed position of said gate valve;
a preloading valve arrangement defining at least one preloading valve, said at least one preloading valve introducing fluid into said valve body chamber at a desired pressure prior to gate operation; and
a means for control.

2. The preloading gate valve system of claim 1, wherein said preloading valve arrangement further comprises at least one preloading relief port.

3. The preloading gate valve system of claim 2, wherein said at least one preloading relief port depends from said valve body chamber to said upstream cavity.

4. The preloading gate valve system of claim 1, wherein said at least one preloading valve is a check valve.

5. The preloading gate valve system of claim 4, wherein said check valve comprises a check valve body, a check valve seal tip, a check valve retainer, a check valve spring, a check valve nut, and a check valve escape port.

6. The preloading gate valve system of claim 1, wherein said at least one preloading valve is either of: a spring-loaded pressure release valve; a ruptured disc and pin valve; or a balanced bellows valve.

7. The preloading gate valve system of claim 1, wherein said means for control is a handwheel attached to a stem.

8. The preloading gate valve system of claim 7, wherein said stem is either of: a rising stem or a non-rising stem.

9. The preloading gate valve system of claim 1, wherein said gate valve is either of:
a sluice valve; a knife gate; a slide gate; a parallel gate valve; a flexible wedge gate valve;
a solid wedge gate valve; a split wedge gate valve; globe valve; or a parallel slide gate valve.

10. A preloading gate valve system comprising:
a gate valve defining a valve body and valve body chamber;
a flow passage extending transversely through said valve body chamber between an upstream cavity and a downstream cavity;
a gate disposed within said valve body chamber, wherein the gate is movable between open and closed position of said gate valve;
a preloading valve arrangement defining an at least one preloading relief port and an at least one preloading valve;
a means for control;
wherein said at least one preloading relief port permits fluid to enter said gate valve at a desired pressure through said least one preloading relief port through said at least one preloading valve, and into the gate valve prior to and during operation of said gate valve, said preloading valve arrangement restricting the flow of dirt, sand, and sediment between said upstream cavity to said valve body chamber; and
wherein said fluid introduced to said valve body chamber by said preloading relief port is sealed from said flow passage.

11. The preloading gate valve system of claim 10, wherein said at least one preloading relief port depends from said valve body chamber to said upstream cavity.

12. The preloading gate valve system of claim 10, wherein said at least one preloading valve is comprised of three stacked check valves.

13. The preloading gate valve system of claim 10, wherein said at least one preloading valve is a check valve.

14. The preloading gate valve system of claim 10, wherein said at least one preloading valve is either of: a spring-loaded pressure release valve; a ruptured disc and pin valve; or a balanced bellows valve.

15. The preloading gate valve system of claim 13, wherein said check valve comprises a check valve body, a check valve seal tip, a check valve retainer, a check valve spring, a check valve nut, and a check valve escape port.

16. The preloading gate valve system of claim 10, wherein said means for control is a handwheel attached to a stem.

17. The preloading gate valve system of claim 16, wherein said stem is either of: a rising stem or a non-rising stem.

18. The preloading gate valve system of claim 10, wherein said gate valve is either of: a sluice valve; a knife gate; a slide gate; a parallel gate valve; a flexible wedge gate valve; a solid wedge gate valve; a split wedge gate valve; globe valve; or a parallel slide gate valve.

19. A preloading gate valve system comprising:
a gate valve defining a valve body and valve body chamber;
a flow passage extending transversely through said valve body chamber between an upstream cavity and a downstream cavity;
a gate disposed within said gate valve, wherein said gate is movable between open and closed position of said gate valve;
a preloading valve arrangement located proximate said upstream cavity, wherein said preloading valve arrangement defines an at least one preloading relief port and an at least one preloading valve;
a means for control;
wherein said at least one preloading relief port extends from a valve body chamber disposed between said upstream cavity and said downstream cavity to said upstream cavity;
wherein said at least one preloading valve allows fluid circulation between said at least one preloading relief port and said valve body chamber;
wherein said at least one preloading valve has at least one escape port; and
wherein said preloading valve arrangement permits the flow of fluid from said upstream cavity to said valve body chamber at a preselected fluid pressure, said preloading valve arrangement restricting the flow of dirt, sand, and sediment between said upstream cavity to said valve body chamber.

20. The preloading gate valve system of claim 19, wherein said at least one preloading valve is comprised of three stacked check valves.

21. The preloading gate valve system of claim 19, wherein said at least one preloading valve is a check valve.

22. The preloading gate valve system of claim 19, wherein said gate valve is either of: a sluice valve; a knife gate; a slide gate; a parallel gate valve; a flexible wedge gate valve; a solid wedge gate valve; a split wedge gate valve; globe valve; or a parallel slide gate valve.

23. The preloading gate valve system of claim 19, wherein said at least one preloading valve is a check valve comprising a check valve body, a check valve seal tip, a check valve retainer, a check valve spring, a check valve nut, and a check valve escape port.

24. The preloading gate valve system of claim 19, wherein said means for control is a handwheel attached to a stem.

25. The preloading gate valve system of claim 24, wherein said stem is either of: a rising stem or a non-rising stem.
